(19) United States
(12) Patent Application Publication
(10) Pub. No.: US 2020/0086323 A1
(43) Pub. Date: Mar. 19, 2020

(54) APPARATUS FOR MAINTAINING LIQUID MEMBRANE AND CHEMICAL SENSOR

(71) Applicant: KABUSHIKI KAISHA TOSHIBA, Minato-ku (JP)

(72) Inventors: Sadato HONGO, Yokohama (JP); Atsunobu Isobayashi, Yokohama (JP); Yoshiaki Sugizaki, Fujisawa (JP); Kei Matsuoka, Kawasaki (JP)

(73) Assignee: KABUSHIKI KAISHA TOSHIBA, Minato-ku (JP)

(21) Appl. No.: 16/298,492

(22) Filed: Mar. 11, 2019

(30) Foreign Application Priority Data
Sep. 18, 2018 (JP) 2018-173937

(51) Int. Cl. B01L 3/00; G01N 27/414

(52) U.S. Cl. CPC B01L 3/52; G01N 27/4141; B01L 3/502; B01L 2300/069; B01L 2300/0645; B01L 2300/0809; B01L 2400/0406

(57) ABSTRACT

According to one embodiment, an apparatus for maintaining a liquid membrane includes a liquid supply mechanism which supplies a liquid to the liquid membrane for wetting a biological substance and a liquid discharge mechanism which discharges the liquid in the liquid membrane.

### CROSS-REFERENCE TO RELATED APPLICATIONS

This application is based upon and claims the benefit of priority from Japanese Patent Application No. 2018-173937, filed Sep. 18, 2018, the entire contents of which are incorporated herein by reference.

### FIELD

Embodiments described herein relate generally to an apparatus for maintaining a liquid membrane and a chemical sensor.

### BACKGROUND

An olfactory sense of a living thing such as a dog has a mechanism that the nose of the living thing has an olfactory receptor, which is a biological substance, therein, binding of an odor substance to the olfactory receptor is detected, a signal is transmitted to the brain, and an odor is recognized. In a case of an actual olfactory sense of a living thing, mucus covers an inner surface of the nose of the living thing so as to prevent an olfactory receptor from being dried and becoming inactive. The mucus is secreted when the olfactory receptor is about to be dried, such that a state where the inner surface of the nose of the living thing is always wet is maintained. There is a demand for maintaining a state where a biological substance is wet with a liquid in order to implement a sensor using such a biological substance.

### BRIEF DESCRIPTION OF THE DRAWINGS

FIG. 1 is a cross-sectional view illustrating an example of a chemical sensor according to a first embodiment.

FIG. 2 is a plan view illustrating an example of the chemical sensor according to the first embodiment.

FIG. 3 is a flowchart illustrating an example of a method of detecting a target substance by using the chemical sensor according to the embodiment.

FIG. 4 is a schematic view illustrating a state of the chemical sensor according to the embodiment when the chemical sensor is used.

FIG. 5 is a view illustrating a chemical sensor including a plurality of types of sensor elements.

FIG. 6 is a cross-sectional view illustrating an example of a chemical sensor according to a second embodiment.

FIG. 7 is a cross-sectional view illustrating an example of a chemical sensor according to a third embodiment.

FIG. 8 is a cross-sectional view illustrating an example of a chemical sensor according to a fourth embodiment.

FIG. 9 is a cross-sectional view illustrating an example of a chemical sensor according to a fifth embodiment.

### DETAILED DESCRIPTION

In general, according to one embodiment, an apparatus for maintaining a liquid membrane includes a liquid supply mechanism which supplies a liquid to the liquid membrane for wetting a biological substance and a liquid discharge mechanism which discharges the liquid in the liquid membrane.

According to one embodiment, a chemical sensor includes a membrane, a biological substance which is fixed on a surface of the membrane, a liquid membrane which covers the membrane and the biological substance, and the apparatus for maintaining the liquid membrane of the embodiment.

According to another embodiment, a chemical sensor includes a membrane, a biological substance which is fixed on a surface of the membrane, a first liquid membrane which covers the membrane and the biological substance, a partition wall which covers the first liquid membrane, a second liquid membrane which covers the partition wall, and an apparatus for maintaining a liquid membrane which makes a liquid in the second liquid membrane flow toward the first liquid membrane and discharges the liquid in the first liquid membrane.

Hereinafter, various embodiments will be described with reference to the accompanying drawings. Each drawing is a schematic diagram for facilitating understanding of each embodiment, and a shape, a dimension, a proportion, and the like in the drawings may be different from actual ones. However, these can be appropriately modified in consideration of the following description and known technologies.

Hereinafter, a chemical sensor according to an embodiment will be described.

### First Embodiment

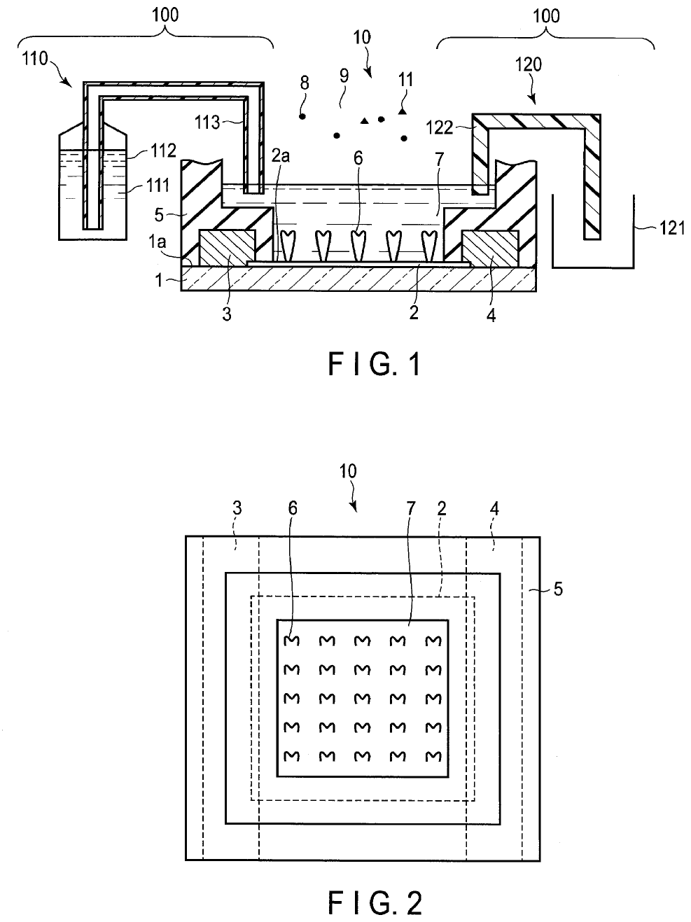

FIG. 1 is a cross-sectional view illustrating an example of a chemical sensor according to a first embodiment, and FIG. 2 is a plan view illustrating an example of the chemical sensor according to the first embodiment. It should be noted that an apparatus for maintaining a liquid membrane 100 illustrated in FIG. 1 is omitted in FIG. 2.

A chemical sensor 10 includes a substrate 1. A membrane 2, a source electrode 3 connected to one end of the membrane 2, and a drain electrode 4 connected to the other end of the membrane 2 are provided on a surface 1a of the substrate 1. A gate electrode (not depicted in the figure) is soaked in the liquid membrane 7. A wall portion 5 is erected on the surface 1a of the substrate 1, surrounds the membrane 2 when viewed in a plane, and covers outer circumferential surfaces of the source electrode 3 and the drain electrode 4. A receptor 6, which is a biological substance, is fixed on a surface 2a of the membrane 2. A liquid membrane 7 including a liquid is disposed on the surface 2a of the membrane 2 so as to cover the receptor 6. The term “cover” in the present embodiment represents covering at least a part. A gas sample 9 containing a target substance 8 is taken into the liquid membrane 7. In addition, the chemical sensor 10 includes the apparatus for maintaining the liquid membrane 100 which maintains a state where the receptor 6 is wet with the liquid membrane 7. The state where the receptor 6 is wet with the liquid membrane 7 indicates a state where the receptor 6 is covered by the liquid membrane 7.

The apparatus for maintaining the liquid membrane 100 includes a liquid supply mechanism 110 which supplies a liquid to the liquid membrane 7 for wetting the biological substance and a liquid discharge mechanism 120 which discharges the liquid in the liquid membrane 7.

The liquid supply mechanism 110 supplies the liquid to the liquid membrane 7 as illustrated in FIG. 1. The liquid supply mechanism 110 includes a liquid supply member. The liquid supply mechanism 110 includes a first container (bottle) 112 which is disposed while being spaced apart from the wall portion 5, is a source of the liquid, and accommodates a liquid 111 therein. An end of a capillary 113 is inserted into the liquid 111 in the bottle 112. The other end of the capillary 113 is disposed to be in contact with the liquid membrane 7. The liquid 111 in the bottle 112 is transferred to the liquid membrane 7 through the capillary 113. The capillary 113 is formed of a material such as glass, and an inner surface of the capillary 113 has hydrophilicity.

Instead of the capillary, a nonwoven fabric can be used as 113. In this case, an end of the nonwoven fabric 113 is inserted into the liquid 111 in the bottle 112. The other end of the nonwoven fabric 113 is disposed to be in contact with the liquid membrane 7. The liquid 111 in the bottle 112 is transferred to the liquid membrane 7 through the nonwoven fabric 113. The nonwoven fabric 113 is formed of polyester, polypropylene, or cellulose.

The liquid supply mechanism 110 can supply the liquid 111 in the bottle 112 to the liquid membrane 7 through the capillary 113 or the nonwoven fabric 113. A capillary phenomenon can be used for the supply. In the liquid supply as described above, it is preferable that the surface 2a of the membrane 2 has hydrophilicity, and it is possible to make the liquid supplied to the liquid membrane 7 rapidly permeate into and spread across the entire surface 2a of the membrane 2 by using the capillary phenomenon.

The liquid discharge mechanism 120 discharges the liquid in the liquid membrane 7 as illustrated in FIG. 1. The liquid discharge mechanism 120 includes a second container 121 which is disposed while being spaced apart from the wall portion 5 and collects the discharged liquid. An end of an absorption member 122 is inserted into the second container 121. The other end of the absorption member 122 is disposed to be in contact with the liquid membrane 7. The absorption member 122 absorbs the liquid in the liquid membrane 7 and transfers the absorbed liquid to the second container 121. The absorption member 122 is formed of a hygroscopic material and an absorbent material including sodium polyacrylate, polyethylene, polystyrene, and the like.

As the liquid supply mechanism 110 supplies the liquid from an end side of the liquid membrane 7 and the liquid discharge mechanism 120 discharges the liquid in the liquid membrane 7 from the other end side of the liquid membrane 7, the apparatus for maintaining the liquid membrane 100 generates a flow of the liquid from one end side of the liquid membrane 7 to the other end side of the liquid membrane 7, thereby making it possible to maintain the state where the receptor 6, which is a biological substance, is wet with the liquid membrane 7. In addition, the apparatus for maintaining the liquid membrane 100 can maintain the liquid membrane 7 to a thickness of 0.5 μm to 10.0 μm.

Hereinafter, components will each be described in detail.

The substrate 1 has, for example, a rectangular plate shape. The substrate 1 is formed of silicon, glass, ceramic, a polymer material, metal, or the like. A size of the substrate 1 is not limited. For example, a width of the substrate 1 is 1 to 10 mm, a length of the substrate 1 is 1 to 10 mm, and a thickness of the substrate 1 is 0.1 to 0.5 mm.

The substrate 1 may include an insulating film (not illustrated) on, for example, the surface 1a. The insulating film is formed of an electrically insulating material such as silicon dioxide, silicon nitride, aluminum oxide, a polymer material, a self-organized membrane of an organic molecule, or the like. The substrate 1 may include the insulating film provided on the surface 1a and a conductor layer which functions as a gate electrode. In this case, it is preferable that the thickness of the insulating film is as small as possible within a range in which an insulating property is not impaired, for example, about several nm. Such a thin membrane can be formed by, for example, an atomic layer deposition (ALD) method.

The membrane 2 is a membrane of which a physical property is changed when a structure of a substance binding thereto or a state of charge is changed. The membrane 2 is formed of, for example, a substance of which electric resistance varies. The membrane 2 is a single-layer graphene membrane having a thickness corresponding to one carbon atom. As the graphene membrane, a multi-layer graphene membrane may also be provided. A size of the membrane 2 is not limited. For example, a width of the membrane 2 can be 1 to 500 μm, and a length of the membrane 2 can be 1 to 500 μm. In practice, it is preferable that the width is 10 to 100 μm and the length is 10 to 100 μm in terms of easy production.

The membrane 2 may be formed of, for example, a membrane of a conductor such as a polymer, silicon (Si), silicide, or a nanowire thereof, or a material such as graphene, a carbon nanotube, molybdenum disulfide (MoS₂) or tungsten diselenide (WSe₂).

The source electrode 3 and the drain electrode 4 is formed of, for example, metal such as gold (Au), silver (Ag), copper (Cu), palladium (Pd), platinum (Pt), nickel (Ni), titanium (Ti), chromium (Cr), or aluminum (Al), or a conductive substance such as zinc oxide (ZnO), indium tin oxide (ITO), indium gallium zinc oxide (IGZO), or a conductive polymer.

The source electrode 3 and the drain electrode 4 are electrically connected to a power supply (not illustrated). The source electrode 3 and the drain electrode 4 are configured so that, for example, a current (source-drain current (I_{sd})) flows from the source electrode 3 to the drain electrode 4 through the membrane 2 when a voltage (source-drain voltage (V_{sd})) is applied from the power supply at a certain gate voltage. At this time, the membrane 2, which is a graphene membrane, functions as a channel with respect to the source electrode 3 and the drain electrode 4.

The wall portion 5 is formed of, for example, an electrically insulating material. Examples of the insulating material of the wall portion 5 include a polymer substance such as an acrylic resin, polyimide, polybenzoxazole, an epoxy resin, a phenol resin, polydimethylsiloxane, or a fluoro resin, an inorganic insulating film such as silicon oxide, silicon nitride, or aluminum oxide, or a self-organized membrane of an organic molecule.

The receptor 6 is a biological substance as described above. As the receptor 6, for example, a fragment of an olfactory receptor can be used. The receptor 6 is a fragment of an olfactory receptor including a sequence of a site binding to the target substance 8. For example, such a sequence includes a ligand binding site of the olfactory receptor, which is positioned extracellularly. The receptor 6 can be produced by, for example, obtaining an amino acid sequence of the ligand binding site from a database of the olfactory receptor, and synthesizing an oligopeptide having the amino acid sequence. The receptor 6 may be a substance binding to the target substance, for example, may be a substance of which a sequence of a ligand binding site is partially changed, or may be a substance to which a new sequence is added. As the olfactory receptor, for example, an olfactory receptor of an animal can be used for the receptor 6. Examples of the animal include a vertebrate or an insect. For example, an olfactory receptor of a human, a mouse, a fly, or the like can be used.

The receptor 6 can be fixed on the membrane 2 by, for example, adding a modified group to the receptor 6 and/or the membrane 2, and binding the modified group and the receptor 6 and/or the membrane 2 to each other through chemical synthesis. The state where the receptor 6 is fixed on the membrane 2 indicates a state where the receptor 6 is connected to the membrane 2 by chemical binding.

It should be noted that a blocking agent (not illustrated) may be disposed on the surface 2a of the membrane 2 so as to cover the surface 2a, in addition to the receptor 6. Examples of the blocking agent can include a protein, an organic molecule, a lipid membrane, a peptide, a nucleic acid, and the like. As the blocking agent as described above is included, it is possible to prevent a non-target substance 11 (for example, impurities) contained in the gas sample 9 from binding to the surface of the membrane 2.

The liquid membrane 7 is disposed on the surface 2a of the membrane 2 so as to cover the receptor 6. The liquid membrane 7 is, for example, a water-soluble liquid such as water, physiological water, or a buffer solution, and serves as a medium carrying the target substance 8 contained in the gas sample 9 to the receptor 6. In addition, since the liquid membrane 7 is disposed so as to cover the receptor 6, it is possible to prevent the receptor 6 from being denaturalized or damaged due to drying of the receptor 6.

The liquid membrane 7 has a thickness of 0.5 μm to 10.0 μm. For example, the thickness of the liquid membrane 7 corresponds to the shortest distance from the surface 2a of the membrane 2 to an interface between the liquid membrane 7 and gas in FIG. 1. When the thickness of the liquid membrane 7 is less than 0.5 μm, a distance by which the target substance 8 contained in the gas sample 9 reaches the receptor 6 is decreased, and sensitivity of the chemical sensor can be improved. However, there is a problem in that it is not possible to prevent the liquid membrane 7 from being dried, which results in denaturalization of or damage to the receptor 6. In contrast, when the thickness of the liquid membrane 7 exceeds 10.0 μm, the distance by which the target substance 8 contained in the gas sample 9 reaches the receptor 6 is increased, such that it is difficult for the target substance 8 to reach the receptor 6. Therefore, there is a problem in that the sensitivity of the chemical sensor deteriorates. It is preferable that the thickness of the liquid membrane 7 is, for example, 0.5 μm to 5.0 μm.

The target substance 8 is a substance which is contained in the gas and can become a ligand of an olfactory receptor of an animal. The target substance 8 is, for example, a volatile organic compound (VOC) such as an odor substance or a pheromone substance. The target substance 8 is, for example, alcohols, esters, aldehydes, ketones, or the like, but is not limited thereto. The target substance 8 as described above is a substance with low water-solubility in many cases.

The gas sample 9 is, for example, a gas to be analyzed which can contain the target substance 8. The gas sample 9 is, for example, air, an exhalation, another gas generated from an analysis target such as a living body, an object, or the like, or air around a corresponding analysis target. The gas sample 9 can contain the non-target substance 11.

As described above, since the chemical sensor 10 includes the liquid membrane 7 disposed on the surface 2a of the membrane 2 so as to cover the receptor 6, and the apparatus for maintaining the liquid membrane 100, it is possible to maintain the state where the receptor 6 is wet with the liquid membrane 7. As a result, it is possible to prevent the receptor 6 from being dried, which results in denaturalization of or damage to the receptor 6.

In addition, since the chemical sensor 10 includes the liquid supply mechanism 110 and the liquid discharge mechanism 120 which are included in the apparatus for maintaining the liquid membrane 100 capable of generating a flow of the liquid from one end side of the liquid membrane 7 to the other end side of the liquid membrane 7, it is possible to form a new liquid membrane 7. As a result, the chemical sensor 10 can repeatedly perform the detection of the target substance 8.

The chemical sensor described above has a configuration of a graphene field effect transistor (hereinafter, referred to as a graphene FET), but is not limited thereto. When a biological substance like the receptor 6 is used, the chemical sensor can have a configuration of, for example, another charge detection element, a surface plasmon resonance (SPR) element, a surface acoustic wave (SAW) element, a film bulk acoustic resonance (FBAR) element, a quartz crystal microbalance (QCM) element, or a micro-electromechanical systems (MEMS) cantilever element.

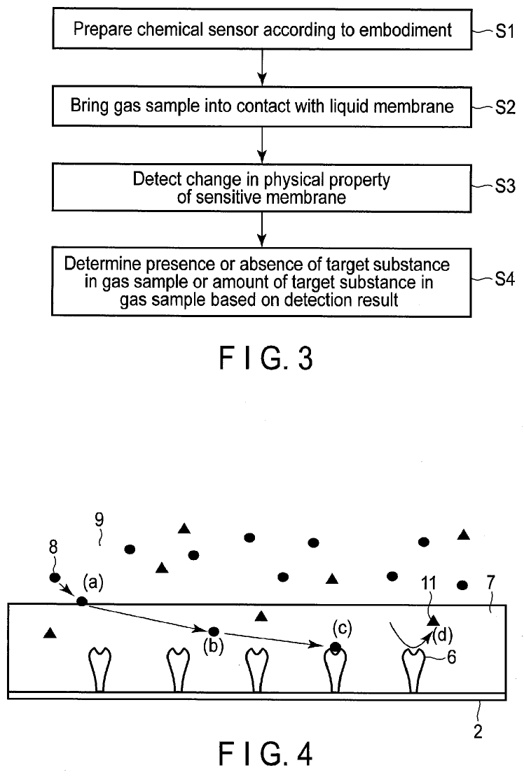

Hereinafter, a method of detecting a target substance by using the chemical sensor according to the embodiment will be described with reference to the flowchart of FIG. 3.

A method of detecting a target substance includes, for example, the following processes: (S1) preparing the chemical sensor according to the embodiment; (S2) bringing the gas sample into contact with the liquid membrane; (S3) detecting a change in a physical property of the membrane; and (S4) determining a presence or absence of the target substance in the gas sample or an amount of target substance in the gas sample based on the detection result.

Hereinafter, a principle according to which the target substance is detected by performing the respective processes will be described.

In the process (S2), the gas sample 9 is brought into contact with the liquid membrane 7 of the chemical sensor 10. A state of the chemical sensor at this time is shown in FIG. 4. The target substance 8 enters ((a) and (b) of FIG. 4) the liquid membrane 7 by contact between the gas sample 9 and the liquid membrane 7, and binds to the receptor 6 ((c) of FIG. 4). Meanwhile, the non-target substance (impurities) 11 does not bind to the receptor 6 ((d) of FIG. 4). The physical property of the membrane 2 is changed by the binding ((c) of FIG. 4) between the target substance 8 and the receptor 6. Examples of the physical property include electric resistance of the membrane.

In the process (S3), the change in the physical property is detected by a change in an electrical signal. Examples of the electrical signal include a current value, a potential value, an electric capacitance value, or an impedance value. The change in the electrical signal is, for example, an increase, a decrease, or loss of the electrical signal, or a change in an integrated value within a certain time. When the graphene FET described above is used, the change in the physical property can be detected as, for example, a change in a source-drain current value when a certain voltage is applied as a gate voltage and a drain voltage. Alternatively, the change in the physical property can be detected as a change in a gate voltage value when the source-drain current value is maintained to be constant. Information on the change in the electrical signal is transmitted to, for example, an electrically connected data processing section, stored, and processed.

In the process (S4), the presence or absence of the target substance 8 in the gas sample 9 or the amount of target substance 8 in the gas sample 9 is determined based on the detection result. For example, when the electrical signal is changed, it may be determined that the target substance 8 is present in the gas sample 9, and when the electrical signal is not changed, it may be determined that the target substance 8 is not present in the gas sample 9. In addition, when a value of the change in the electrical signal is larger than a preset threshold value, it may be determined that the target substance 8 is present in the gas sample 9, and when the value of the change in the electrical signal is smaller than the threshold value, it may be determined that the target substance 8 is not present in the gas sample 9. Such a threshold value can be obtained in advance by, for example, using a gas sample which is known to contain the target substance for analysis of the chemical sensor and obtaining a value of a change in the electrical signal. Alternatively, the amount of target substance may be determined based on a variation in the amount of electrical signal. In this case, a target substance of which a concentration is known is used to generate a calibration curve of the variation in the amount of electrical signal with respect to a concentration of the target substance, and the amount of target substance may be determined based on the calibration curve.

By the processes described above, the chemical sensor according to the embodiment can detect the target substance in the gas sample.

In addition, since the chemical sensor according to the embodiment includes the apparatus for maintaining the liquid membrane, a new liquid membrane is formed after detecting the target substance in the gas sample, such that it is possible to repeatedly perform the detection of the target substance described above.

The method of detecting a target substance may be performed by an apparatus automatically performing each process. Such an apparatus includes, for example, the chemical sensor 10, a detection section which converts the change in the physical property of the membrane 2 into the change in the electrical signal, a data processing section which stores and processes information on the electrical signal obtained from the detection section, and a control section which controls the operation of each of these sections. The operations in the processes (S2) to (S4) may be executed by an input from an operator of the apparatus or may be executed by a program included in the control section.

According to the method of detecting a target substance using the chemical sensor according to the embodiment, since the receptor binding to the target substance is used, it is possible to prevent the non-target substance (impurities) from being detected. Therefore, even under a condition in which compositions of substances contained in the gas are different, it is possible to detect the target substance without being affected by the impurities.

Hereinafter, a unit including the substrate 1, the membrane 2, the source electrode 3, the drain electrode 4, the wall portion 5, one type of receptor 6, the liquid membrane 7, and the apparatus for maintaining the liquid membrane 100 will be referred to as a “sensor element”. According to several embodiments, a plurality of types of sensor elements can be mounted in one chemical sensor. The plural types of sensor elements each include a different receptor 6, and each can detect a different kind of target substance.

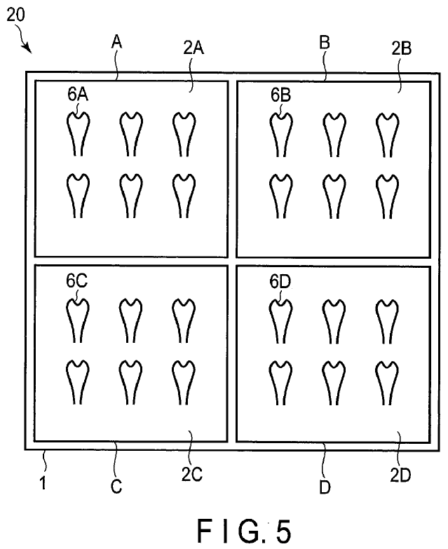

The chemical sensor including the plural types of sensor elements will be described with reference to FIG. 5.

A chemical sensor 20 in this example includes a sensor element A comprising a receptor 6A fixed to a membrane 2A, a sensor element B comprising a receptor 6B fixed to a membrane 2B, a sensor element C comprising a receptor 6C fixed to a membrane 2C, and a sensor element D comprising a receptor 6D fixed to a membrane 2D.

Each of the membranes 2A to 2D of the respective sensor elements is configured to be capable of individually detecting a change in a physical property thereof.

The number, the type, disposition, or the like of the sensor element mounted in one chemical sensor are not limited those illustrated in FIG. 5. In addition, each type of sensor element may be provided in plural.

The method of detecting a target substance when the chemical sensor includes the plural types of sensor elements will be described with reference to FIG. 5.

In such a method of detecting a target substance, the processes (S1) to (S3) are performed in the same manner by using the chemical sensor 20 of FIG. 5. In the process (S3), an electrical signal can be obtained individually from the respective sensor elements A to D. In the process (S4), the kind of target substance mixture containing a plurality of target substances may be specified based on the kind (the kind of receptor fixed to a corresponding sensor element) and the number of sensor elements in which an electrical signal is changed. For example, it can be determined that a target substance mixture I is present in a gas sample when the electrical signal is changed in the sensor elements A and B, and that a target substance mixture II is present in the gas sample when the electrical signal is changed in the sensor elements A, C, and D. Alternatively, in the chemical sensor in which each type of sensor element is provided in plural, a presence or absence of a certain target substance mixture may be determined based on an intensity ratio of the electrical signals detected in the sensor elements A, B, C, and D. In addition, it is possible to specify the kind of target substance mixture contained in the gas sample based on the intensity ratio.

The target substance mixture is a mixture in which a plurality of target substances are mixed with each other in a certain combination, and, for example, one certain “odor” may be associated with the target substance mixture, thereby determining a presence or absence, or an amount of “odor” by using the method. In addition, an “odor” and a cause of the “odor” can be associated with each other in advance, thereby specifying the cause of the odor by the detection as described above.

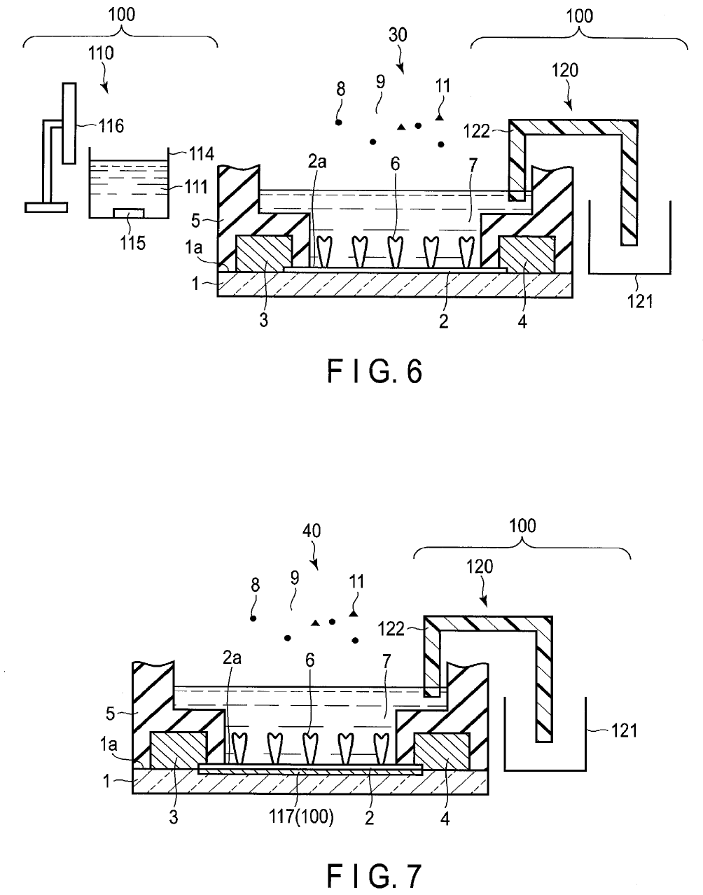

Hereinafter, chemical sensors according to other embodiments will be described with reference to FIGS. 6 to 9. It should be noted that, in FIGS. 6 to 9, the same members as those in FIG. 1 will be denoted by the same reference numerals and a description thereof will be omitted.

### Second Embodiment

FIG. 6 is a cross-sectional view illustrating an example of a chemical sensor according to a second embodiment. A chemical sensor 30 illustrated in FIG. 6 has the same structure as that of the chemical sensor illustrated in FIG. 1, except for a configuration of a liquid supply mechanism 110.

The liquid supply mechanism 110 supplies a liquid to a liquid membrane 7 as illustrated in FIG. 6. The liquid supply mechanism 110 includes a first container (cup) 114 which is disposed while being spaced apart from a wall portion 5, is a source of the liquid, and accommodates a liquid 111 therein. An ultrasonic oscillator 115 is provided on a bottom portion of the cup 114. The ultrasonic oscillator 115 oscillates at a frequency of, for example, 180 Hz to 2.4 MHz to cause the liquid 111 in the cup 114 to turn into mist. A fan 116 is installed at the opposite side of the cup 114 from the wall portion 5 while being spaced apart from the cup 114. The fan 116 generates the wind toward the liquid membrane 7. The fan 116 blows the mist of the liquid 111 to a surface of the liquid membrane 7 by the wind. The fan 116 can blow a gas sample 9 containing a target substance 8 together with the mist to the liquid membrane 7. Here, in order to facilitate blowing of the mist to the surface of the liquid membrane 7 by the wind generated by the fan 116, that is, in order to facilitate supply of the liquid to the liquid membrane 7, a plate for guiding the wind generated by the fan 116 to the surface of the liquid membrane 7 may be provided above the surface of the liquid membrane 7.

In the liquid supply mechanism 110 described above, the ultrasonic oscillator 115 oscillates to cause the liquid 111 in the cup 114 to turn into mist to generate the mist and the mist is blown to the surface of the liquid membrane 7 by the wind generated by the fan 116, thereby supplying the liquid to the liquid membrane 7.

Therefore, the chemical sensor 30 can also blow the gas sample 9 containing the target substance 8 to the liquid membrane 7 by the wind generated by the fan 116, in addition to exerting the same action and effect as those of the above-described chemical sensor 10 according to the first embodiment illustrated in FIG. 1. As a result, the chemical sensor 30 can have improved sensitivity in detection of the target substance.

### Third Embodiment

FIG. 7 is a cross-sectional view illustrating an example of a chemical sensor according to a third embodiment. A chemical sensor 40 illustrated in FIG. 7 has the same structure as that of the chemical sensor illustrated in FIG. 1, except for a configuration of a liquid supply mechanism 110.

The liquid supply mechanism 110 is disposed between a substrate 1 and a membrane 2 and includes a Peltier element 117 buried in a surface 1a of the substrate 1, as illustrated in FIG. 7.

The Peltier element 117 cools the membrane 2 and a liquid membrane 7 to condense steam in the air, thereby supplying a liquid to the liquid membrane 7. Here, the liquid supply mechanism 110 may include a container (not illustrated) in which the liquid is accommodated as a source of the liquid. For example, the source of the liquid as described above is installed while being spaced apart from a wall portion 5. Since an activity of a receptor 6 can be decreased when cooling the membrane 2 and the liquid membrane 7, it is preferable to stop the cooling by the Peltier element 117 after supplying the liquid to the liquid membrane 7.

In the liquid supply mechanism 110 described above, the Peltier element 117 cools the membrane 2 and the liquid membrane 7 to generate condensate water from the air, thereby supplying the condensate water to the liquid membrane 7.

Therefore, the chemical sensor 40 exerts the same action and effect as those of the above-described chemical sensor 10 according to the first embodiment illustrated in FIG. 1.

The combination of the second embodiment and the third embodiment can be possible.

### Fourth Embodiment

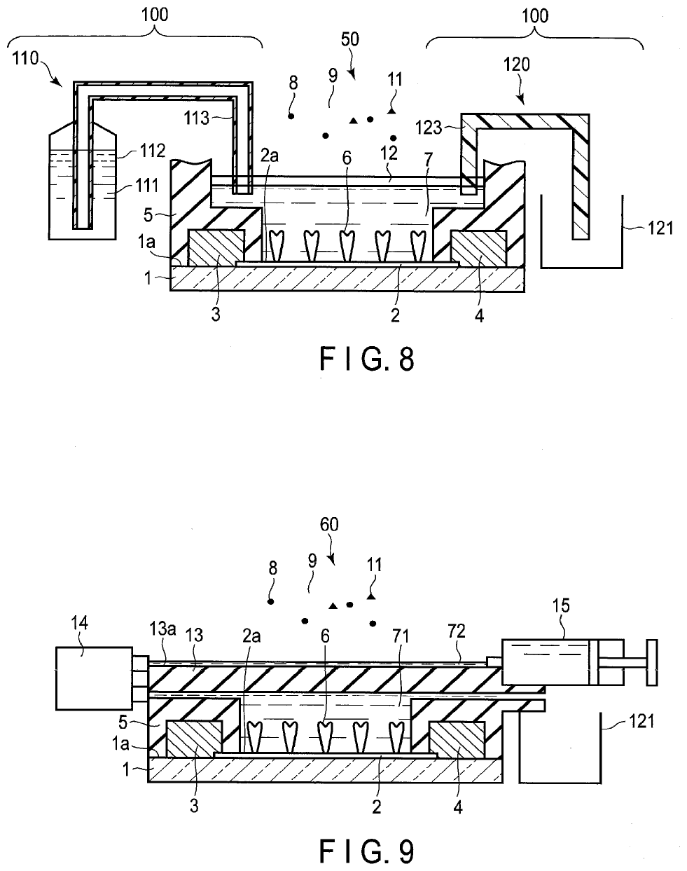

FIG. 8 is a cross-sectional view illustrating an example of a chemical sensor according to a fourth embodiment. A chemical sensor 50 illustrated in FIG. 8 has the same structure as that of the chemical sensor illustrated in FIG. 1, except for further including an oil membrane 12 disposed so as to cover a surface of a liquid membrane 7 and including a different liquid discharge mechanism 120.

The oil membrane 12 is disposed so as to cover the surface of the liquid membrane 7. A thickness of the oil membrane 12 is, for example, 10 nm to 3.0 μm. The oil membrane 12 can be formed on the surface of the liquid membrane 7 by dropping oil droplets. The oil membrane 12 has higher affinity with a target substance than that of the liquid membrane 7, such that the target substance rapidly passes through the oil membrane 12 toward the liquid membrane 7. Therefore, the oil membrane 12 can suppress or prevent a receptor 6 from being dried, which results from evaporation of the liquid membrane 7, without disturbing the target substance from reaching the receptor 6.

An absorption member 123 has an end disposed in a second container 121 and the other end disposed to be in contact with the liquid membrane 7 and the oil membrane 12. The absorption member 123 transfers the liquid in the liquid membrane 7 and the oil in the oil membrane 12 to the second container 121. The absorption member 123 is formed of a material including polypropylene, polyethylene, and the like.

Therefore, the chemical sensor 50 can further prevent the receptor 6 from being denaturalized or damaged due to drying of the receptor 6, in addition to exerting the same action and effect as those of the above-described chemical sensor 10 according to the first embodiment illustrated in FIG. 1.

### Fifth Embodiment

FIG. 9 is a cross-sectional view illustrating an example of a chemical sensor according to a fifth embodiment.

In a chemical sensor 60 illustrated in FIG. 9, a first liquid membrane 71 including a liquid is disposed on a surface 2a of a membrane 2 so as to cover a receptor 6, unlike the chemical sensor 10 illustrated in FIG. 1. A partition wall 13 is disposed on the first liquid membrane 71 so as to cover the first liquid membrane 71. A second liquid membrane 72 is disposed on the partition wall 13 so as to cover the partition wall 13. A gas sample 9 containing a target substance 8 is taken into the second liquid membrane 72. In addition, the chemical sensor 60 includes an apparatus for maintaining a liquid membrane 14 which makes a liquid in the second liquid membrane 72 flow toward the first liquid membrane 71 and discharges the liquid in the first liquid membrane 71.

The first liquid membrane 71 is disposed on the surface 2a of the membrane 2 so as to cover the receptor 6. The first liquid membrane 71 is, like the liquid membrane 7 described above, a water-soluble liquid such as water, physiological water, a buffer solution, or the like, and serves as a medium carrying the target substance 8 contained in the gas sample 9 to the receptor 6. In addition, since the first liquid membrane 71 is disposed so as to cover the receptor 6, it is possible to prevent the receptor 6 from being denaturalized or damaged due to drying of the receptor 6.

The partition wall 13 is disposed so as to cover the surface of the first liquid membrane 71. It is preferable that a surface 13a of the partition wall 13 has hydrophilicity by super-hydrophilization. For example, in the partition wall 13, the surface 13a is coated with TiO₂, thereby making it possible to improve hydrophilicity.

The second liquid membrane 72 is disposed so as to cover the surface 13a of the partition wall 13. The second liquid membrane 72 is, like the liquid membrane 7 described above, a water-soluble liquid such as water, physiological water, a buffer solution, or the like, and serves as a medium into which the target substance 8 contained in the gas sample 9 is taken.

The apparatus for maintaining the liquid membrane 14 is, for example, a micro-electromechanical systems pump (MEMS PUMP). The apparatus for maintaining the liquid membrane 14 makes the liquid in the second liquid membrane 72, in which the target substance 8 is included, flow toward the first liquid membrane 71 and discharges the liquid in the first liquid membrane 71 to the second container 121.

A syringe 15 is disposed at an end of the surface 13a of the partition wall 13. The syringe 15 is a source of a liquid including a water-soluble liquid such as water, physiological water, a buffer solution, or the like.

Accordingly, since the first liquid membrane 71 in which the target substance 8 contained in the gas sample 9 is carried to the receptor 6, and the second liquid membrane 72 into which the target substance 8 in the gas sample 9 is taken, are separately configured in the chemical sensor 60 illustrated in FIG. 9, it is possible not only to prevent the receptor 6 from being denaturalized or damaged due to drying of the receptor 6, but also to detect the target substance in another gas sample by refreshing the first liquid membrane 71, thereby enabling repetitive measurement.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for maintaining a liquid membrane, comprising:
a liquid supply mechanism configured to supply a liquid to the liquid membrane for wetting a biological substance; and
a liquid discharge mechanism configured to discharge the liquid in the liquid membrane.

2. The apparatus of claim 1, wherein the liquid supply mechanism includes a first container configured to accommodate a liquid therein and a liquid supply member configured to supply the liquid to the liquid membrane by using a capillary phenomenon.

3. The apparatus of claim 2, wherein the liquid supply member is a capillary having an end inserted into the first container and the other end disposed to be in contact with the liquid membrane.

4. The apparatus of claim 2, wherein the liquid supply member is a nonwoven fabric having an end inserted into the first container and the other end disposed to be in contact with the liquid membrane.

5. The apparatus of claim 1, wherein the liquid discharge mechanism includes a second container configured to collect a discharged liquid and an absorption member having an end inserted into the second container and the other end disposed to be in contact with the liquid membrane, and absorbs and discharges the liquid in the liquid membrane by using the absorption member.

6. The apparatus of claim 1, wherein the apparatus for maintaining the liquid membrane maintains the liquid membrane to a thickness of 0.5 μm to 10.0 μm.

7. The apparatus of claim 1, further comprising an oil membrane disposed on a surface of the liquid membrane.

8. The apparatus of claim 1, wherein the biological substance is a receptor.

9. The apparatus of claim 1, wherein the biological substance binds to a target substance in a gas sample.

10. A chemical sensor, comprising:
a membrane;
a biological substance fixed on a surface of the membrane;
a liquid membrane covering the membrane and the biological substance; and
the apparatus for maintaining the liquid membrane of claim 1.

11. The chemical sensor of claim 10, further comprising:
a source electrode connected to an end of the membrane; and
a drain electrode connected to the other end of the membrane,
wherein the membrane includes graphene.

12. The chemical sensor of claim 10, wherein the biological substance binds to a target substance.

13. A chemical sensor, comprising:
a membrane;
a biological substance fixed on a surface of the membrane;
a first liquid membrane covering the membrane and the biological substance;
a partition wall covering the first liquid membrane;
a second liquid membrane covering the partition wall; and
an apparatus for maintaining a liquid membrane configured to make a liquid in the second liquid membrane flow toward the first liquid membrane and discharge the liquid in the first liquid membrane.
